(19) United States
(12) Patent Application Publication
(10) Pub. No.: US 2008/0193260 A1
(43) Pub. Date: Aug. 14, 2008

(54) Remote Control Device

(76) Inventors: Yasuyoshi Yokokohji, Kyoto (JP); Yuji Sato, Kyoto (JP); Kohei Kawata, Kyoto (JP); Koji Shiratsuchi, Kyoto (JP)

Correspondence Address: HARNESS, DICKEY & PIERCE, P.L.C., P.O. BOX 8910, RESTON, VA, 20195, US

(21) Appl. No.: 11/921,099

(22) PCT Filed: May 10, 2006
(86) PCT No.: PCT/JP2006/309392

§ 371 Date: Feb. 27, 2008

(30) Foreign Application Priority Data
May 31, 2005 (JP) 2005-160186

(51) Int. Cl. B25J 3/00; B25J 13/02

(52) U.S. Cl. 414/1; 901/4

(57) ABSTRACT

In one embodiment of the present invention, a remote control device is disclosed which enables a user to intuitively operate a target to control such as a robot arm with a little burden, and command various motions to the target. The remote control device includes a master arm main body, joints, and a handgrip controller, and an elbow switch. The master arm main body conveys motions of the user's arm to the robot arm. The elbow switch is provided at a position of the master arm body, on which the user can place his elbow, and has a motion control with 2 degrees of freedom.

### TECHNICAL FIELD

The present invention relates to a remote control device for remotely controlling a robot arm.

### BACKGROUND ART

Generally, movement degree of freedom of a robot arm operated by a remote control device called a master arm is at most 6 degrees of freedom. Therefore, the use of the master arm to control the robot arm faces no problem as long as the robot arm has 6 degrees of freedom or less. However, in order to remotely control a robot arm having redundant degrees of freedom such as a humanoid robot, an additional input unit is required.

Conventionally, a handgrip controller of a remote control device is provided with a switch for controlling a position of an elbow joint of a robot arm (see Patent Citation 1). Also, Patent Citation 2 disclosed that a photoelectronic sensor or a micro linear scale is used for detecting motions of an operator's elbow in a non-contact manner. Moreover, a technique of controlling a robot arm by an acceleration sensor attached to an operator's elbow has been proposed (see Non-Patent Citation 1 and Non-Patent Citation 2).

[Patent Citation 1] Japanese Unexamined Patent Publication, Tokukaihei, No. 5-228854 (published on Sep. 7, 1993)
[Patent Citation 2] Japanese Unexamined Patent Publication, Tokukai, No. 2001-300871 (published on Oct. 30, 2001)
[Non-Patent Citation 1] Yoshiaki ASAHARA and 4 others, “Study on Tele-existence (37^{th} report)—Development of Master Arm TELESER II (1)—”, the 4^{th} System Integration Division Annual Conference (SI2003) on Dec. 19, 2003
[Non-Patent Citation 1] Yoshiaki ASAHARA and 4 others, “Study on Tele-existence (38^{th} report)—Development of Master Arm TELESER II (2)—”, the 4^{th} System Integration Division Annual Conference (SI2003) on Dec. 19, 2003

### DISCLOSURE OF INVENTION

However, in the arrangement in which the robot arm is controlled by the switch provided at a handgrip controller as described in Patent Citation 1, actual actions of the robot arm are vastly different from the operator's action of pressing the switch. So, an operator cannot intuitively control the robot arm.

Moreover, in the method described in Patent Citation 2, the non-contact detection of the motions of the operator's elbow requires that the operator should keep an elbow up. So, the operator's arm may easily become tired. Furthermore, in the arrangement in which the acceleration sensor is attached to the elbow, as described in Non-Patent Citations 1 and 2, the operator's arm may easily become tired, too.

Especially, when an operator handles double master arms for operating a double arm robot, operator's arms are tied down. So, it is more difficult for the operator to handle additional switches.

Another remote control device of a robot arm, called exoskelton, has an arm which is formed to be fit with a bone structure of an operator's arm from the outside. The device enables an operator to handle a robot arm throughout almost the same working range as the operator's arm. But the device cannot be provided with an armrest where the operator can place an arm. So, the operator's arm may easily become tired after long-hour control operation.

Furthermore, a remote control device with a fixed armrest which is often used for a surgery robot is adequate for endoscopic operation which requires a limited working range. But, the device is not adequate for general remote control devices which need to operate a robot arm in a wide range.

The present invention is accomplished in the view to the above problems. An object of the present invention is to provide a remote control device by which a user can intuitively operate a robot arm with a little burden, and can command various movements to a robot arm.

In order to achieve the above object, a remote control device of the present invention includes a master arm main body for conveying a motion of a user's arm to a robot arm and an elbow switch at that position of the master arm main body on which a user places his elbow. The elbow switch allows a motion control of at least 2 degrees of freedom.

With this configuration, in addition to the degrees of freedom by the master arm main body, the remote control device includes a motion control with 2 degrees of freedom provided from the elbow switch. That is, the remote control device enables a user to operate the robot arm and the like with higher degrees of freedom.

As motions of the user's arm are conveyed to the robot arm by the master arm, the user can operate the robot arm as if it is a user's own arm. So, the user can command more various motions to the robot arm.

Moreover, by providing the elbow switch at that position where a user places an elbow, it becomes possible for the user to operate the elbow switch while placing his elbow on the elbow switch. As a result, the user can intuitively operate the elbow switch with his own elbow, and long-hour control operation of the target to control becomes less fatiguing.

As described above, in accordance with the remote control device of the present invention, as the elbow switch allows a motion control of at least 2 degrees of freedom, the user can operate targets to control with higher degrees of freedom such as a robot arm or the like. As motions of the user's arm are conveyed to the robot arm by the master arm main body, the user can operate the robot arm as if it is a user's own arm. So, the user can command more various motions to the robot arm. Moreover, the user can intuitively operate the elbow switch with his own elbow, and long-hour control operation of the target to control becomes less fatiguing.

### BRIEF DESCRIPTION OF DRAWINGS

FIG. 1 is a perspective view illustrating a configuration of a master arm in accordance with an embodiment of a remote control device of the present invention.

FIG. 2 is a view schematically illustrating a configuration of the master arm of FIG. 1.

FIG. 3 (a) illustrates how a user operates the master arm of FIG. 1.

FIG. 3 (b) illustrates how a user operates the master arm of FIG. 1.

FIG. 4 illustrates a configuration of an armrest in the master arm of FIG. 1.

FIG. 5 illustrates an elbow switch attached to the master arm of FIG. 1.

FIG. 6 (a) illustrates details of a configuration of the elbow switch in the master arm of FIG. 1.

FIG. 6 (b) illustrates details of the configuration of the elbow switch in the master arm of FIG. 1.

FIG. 6 (c) illustrates details of the configuration of the elbow switch in the master arm of FIG. 1.

FIG. 7 illustrates a configuration of a handgrip controller in the master arm of FIG. 1.

FIG. 8 (a) illustrates a preferable configuration of the handgrip controller provided in the master arm of FIG. 1.

FIG. 8 (b) illustrates a preferable configuration of the handgrip controller provided in the master arm of FIG. 1.

FIG. 9 (a) illustrates how a user moves the handgrip controller of the master arm of FIG. 1.

FIG. 9 (b) illustrates how a user moves the handgrip controller of the master arm of FIG. 1.

### EXPLANATION OF REFERENTIAL NUMERALS

1: Master Arm (Remote Control Device)
2a to 7a, 2b to 7b, 8: Master Arm Main Body
10: Elbow Switch
9: Arm Rest
2b to 7b: Joint

### BEST MODE FOR CARRYING OUT THE INVENTION

1. Outline of Master Arm

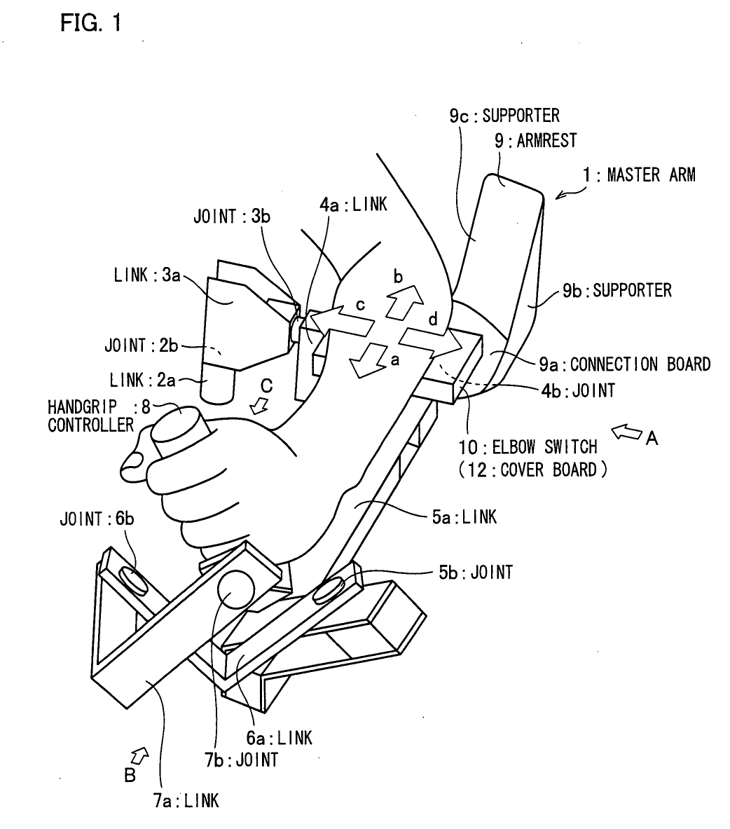

One embodiment of the present invention is described below. As illustrated in FIG. 1, a master arm 1, which is a remote control device, includes links 2a, 3a, 4a, 5a, 6a, 7a, and a handgrip controller 8. Each of these links 2a through 7a is connected respectively by joints 2b, 3b, 4b, 5b, 6b, and 7b. In addition, an armrest 9 is fixed to the link 5a, and an elbow switch 10 is fixed to the link 4a.

Thus, the master arm 1 has a configuration that fits with a bone structure of a use's arm by the links 2a through 7a, joints 2b through 7b, and handgrip controller 8 being connected respectively. In claims, a mechanism including the links 2a through 7a, joints 2b through 7b, and handgrip controller 8 is recited as a “master arm main body”.

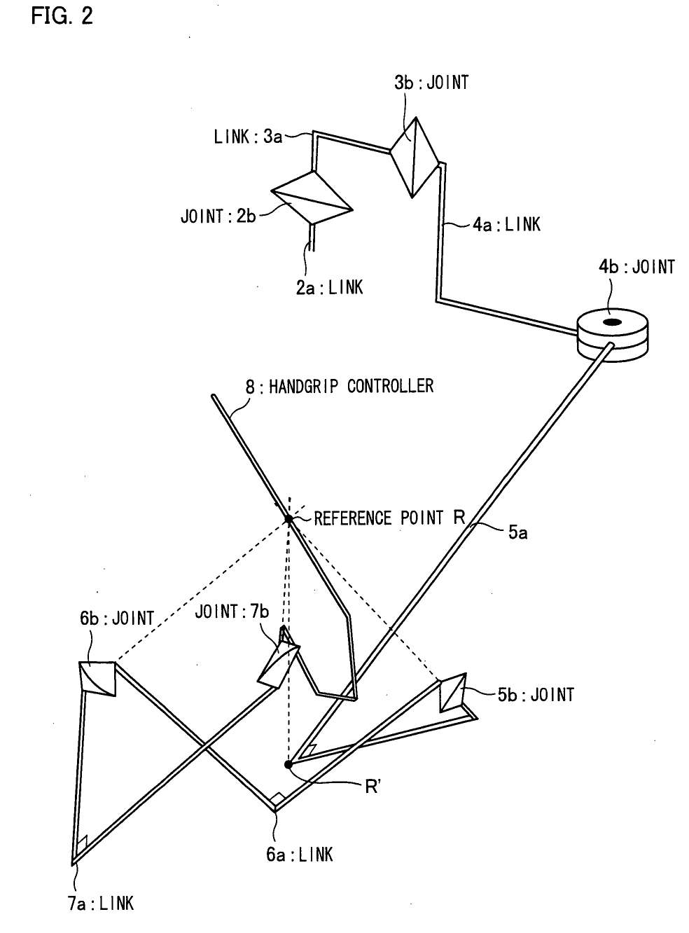

In FIG. 1, the link 4a, link 5a, joint 2b, and joint 4b are illustrated behind the links and an elbow switch, and it may be incomprehensible in how these components are connected. So, a simplified configuration including the links 2a through 7a, handgrip controller 8, and joints 2b through 7b is illustrated in FIG. 2.

As illustrated in FIG. 2, the link 2a is connected with the link 3a through the joint 2b. Thus, the links 2a and 3a are connected through the joint 2b so that the link 3a can move rotationally in relation to the link 2a.

The link 3a connects the joints 2b and 3b so that the joints 2b and 3b are disposed in a L-shaped arrangement, and also is connected with the link 4a through the joint 3b. Thus, the links 3a and 4b are connected through the joint 3b so that the link 4a can move rotationally in relation to the link 3a.

Especially, it is preferable that a rotating axis of the joint 3b (which allows up-and-down movement of a user's forearm) pass through a contact point between the user's elbow and armrest 9, or through a point slightly inside the user's forearm from the contact point. With this arrangement, the user can make natural rotating movement via the joint 3b without moving his shoulder, or upper body.

The links 4a, 5a, 6a, and 7a are L-shaped as well as the link 3a, and each of the links is respectively connected with the joints 4a, 5b, 6b, or 7b. The handgrip controller 8 is connected with the link 7a through joint 7b.

Thus, each of the links 2a through 7a and handgrip controller 8 in the master arm 1 is respectively connected through each of the joints 2b through 7b so that the adjoining links, or the adjoining link and handgrip controller can move rotationally in relation to each other.

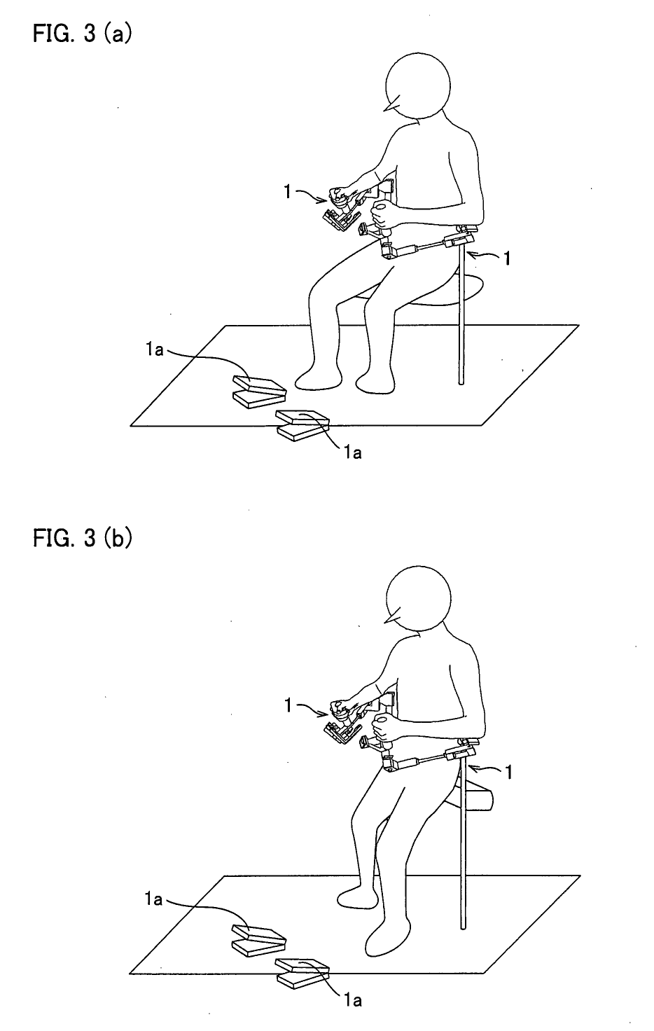

Referring to FIGS. 3 (a) and (b), how a user operates the master arm 1 is described below. As illustrated in FIG. 3 (a), the master arms 1 are provided to the right arm and the left arm respectively so that a user can put his arms on master arms 1. The master arm 1 may be provided for either of the arms.

A seat may be adjusted as appropriate depending on the environment where the master arm 1 is provided. For example, the seat may be such a seat as illustrated in FIG. 3 (a) that a user can sit back and operate the master arm 1. As an alternative, the seat may be such a seat as illustrated in FIG. 3 (b) that a user can operate the master arm 1 in a half-sitting posture.

2. Configuration of Armrest

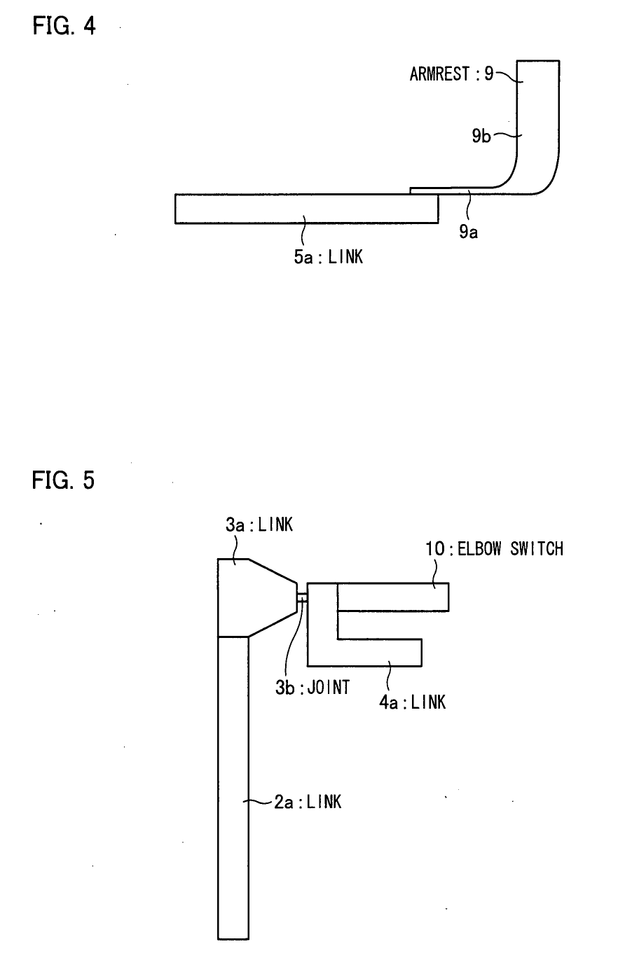

In FIG. 1, the armrest 9 and elbow switch 10 are illustrated behind a user's arm. So, a configuration of the armrest 9 and elbow switch 10 may be incomprehensible. FIG. 4 and FIG. 5 illustrate the configuration of the armrest 9 and elbow switch 10.

FIG. 4 illustrates how the link 5 and armrest 9 are connected when seen from the direction A of FIG. 1. As illustrated in FIG. 4, the armrest 9 has an L-shaped cross section, and is fixed at one end of the link 5a.

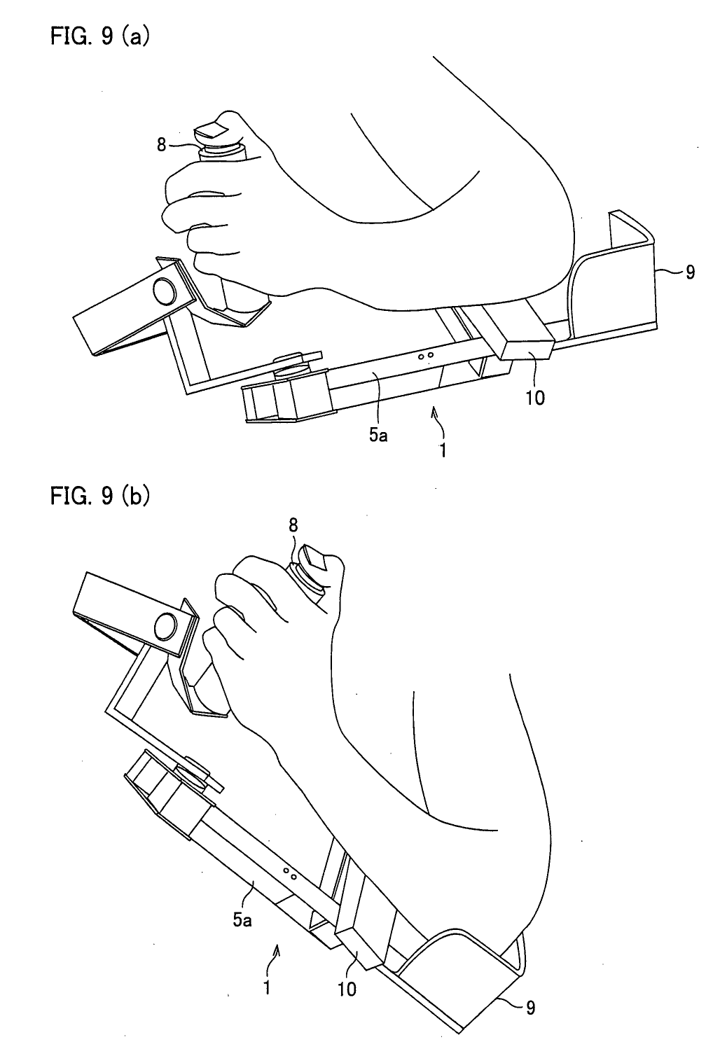

The armrest 9 arranged as described above can work as a counterbalance for the rotational movement of the link 5a in relation to the link 4a, if a proper weight is added on a part of the armrest 9. It means that when the user in FIG. 9 (a) raises the handgrip controller 8 to the position illustrated in FIG. 9 (b), the armrest 9 works as the counterbalance, whereby the user can operate the master arm more easily. The armrest 9 may have any size depending on a user.

The armrest 9, as illustrated in FIG. 1, includes a connection board 9a fixed to the link 5a and supporters 9b and 9c extending from the connection board 9a.

The connection board 9a is a board which stretches out in a longitudinal direction of the link 5a and a longitudinal direction of the link 4a. The supporter 9b is a board which is disposed substantially at the right angle to the longitudinal direction of the link 4a, extending from the connection board 9a. The supporter 9c is a board which is disposed substantially at almost the right angle to the longitudinal direction of the link 5a, extending from the connection board 9a and supporter 9b.

With the armrest 9 described above, the supporter 9b and supporter 9c function to support the user's elbow when the user operates the master arm 1.

It means that when the user raises his forearm rotating the joint 3, a weighted point of the forearm moves on the elbow switch 10 and the forearm would drop off from the elbow switch 10. In such case, the supporter 9c supports the forearm so that the user's elbow does not slide off.

When the user moves his forearm in a circular motion rotating the joint 4b, the forearm may slide out of the elbow switch 10 by chance, whereby the elbow switch 10 cannot follow motions of the user's elbow. To solve this problem, the supporter 9b controls motions of the user's forearm so that the elbow switch 10 can properly follow motions of the user's forearm.

3. Configuration of Elbow Switch

FIG. 5 illustrates a configuration of the links 2a, 3a, 4a, joint 3b, and elbow switch 10 when the master arm 1 is seen from the direction of B in FIG. 1. As illustrated in FIG. 5, the elbow switch 10 is fixed to the link 4a, extending from the location where the link 4a is connected with the joint 3b to the same direction where the link 4a extends.

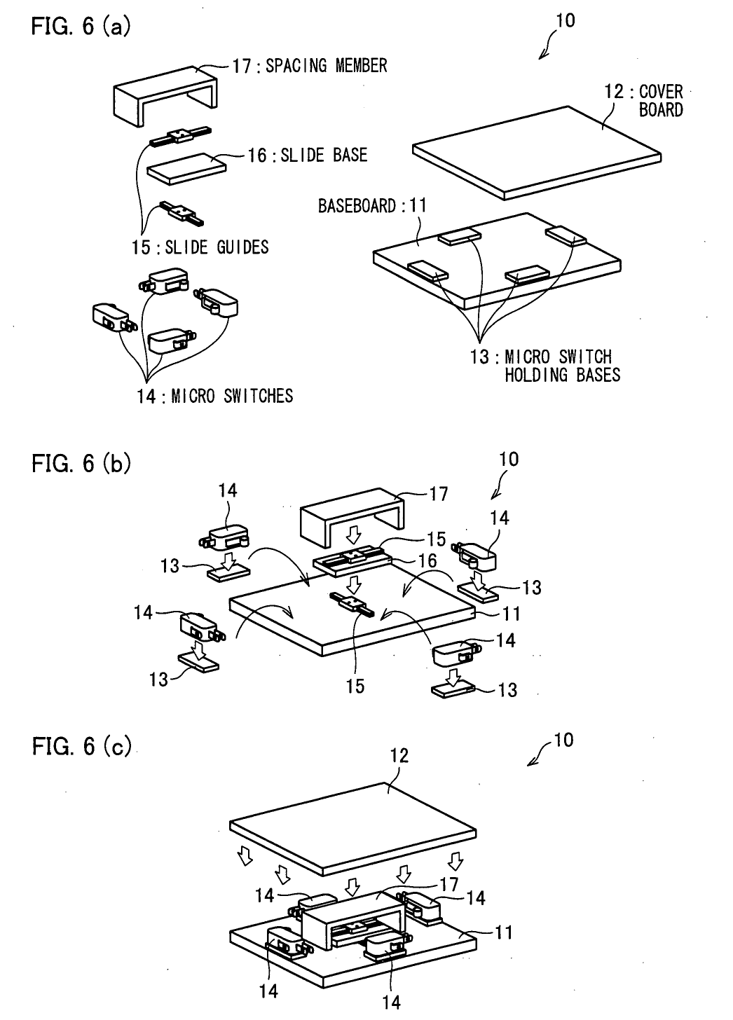

FIG. 1 and FIG. 5 illustrate the elbow switch 10 in a simple rectangular shape for easy explanation. More specifically, the elbow switch 10 includes slide guides and micro switches so that the elbow switch 10 can move to the directions a through d in FIG. 1. FIG. 6 (a) through (c) illustrate a detailed configuration of the elbow switch 10 as below.

As illustrated in FIG. 6 (a), the elbow switch 10 includes a baseboard 11, a cover board 12, micro-switch holding bases 13, four micro switches 14, two slide guides 15, a slide base 16, and a spacing member 17 having a U-shaped cross section.

FIG. 6 (b) illustrates how to assemble the micro switches 14 and slide guides 15. As illustrated in FIG. 6 (b), each micro switch 14 is respectively fixed on each micro-switch holding bases 13. Then, the micro-switch holding bases 13 are fixed on the baseboard 11.

One of the slide guides 15 is fixed on the baseboard 11. Another slide guide 15 fixed on the slide base 16 is fixed on the slide guide 15. Furthermore, the spacing member 17 is attached to the another slide guide 15 fixed on the slide base 16. Both slide guides 15 includes a block, and a linear rail where the block moves.

The two slide guides 15 are crisscrossed on the baseboard 11 so that the blocks move crosswise. It enables the spacing member 17 to move crosswise on the baseboard 11. Four micro switches 14 are respectively fixed at four directions of the spacing member 17 so that it is possible to detect, by using the micro switches 14, how much distance the spacing member 17 is moved in the 4 directions.

Furthermore, as illustrated in FIG. 6 (c), the cover board 12 is fixed on the spacing member 17. Thereby, assembling of the elbow switch 10 is completed. The user places his elbow on the cover board 12 (see FIG. 1).

With the elbow switch 10 as described above, the cover board 12 and spacing member 17 are moved as the user's elbow placed on the cover board 12 moves. By using the micro switches 14, the distances of the movement of the spacing member 17 are detected in the four directions. Accordingly, the distances of the movement of the user's elbow in the four directions are detected by using the micro switches 14.

The motion of the user's elbow detected by the elbow switch 10 is conveyed to the robot arm. In this way, the master arm 1 of the embodiment can command various motions to the robot arm. The details are described later.

4. Configuration of Handgrip Controller

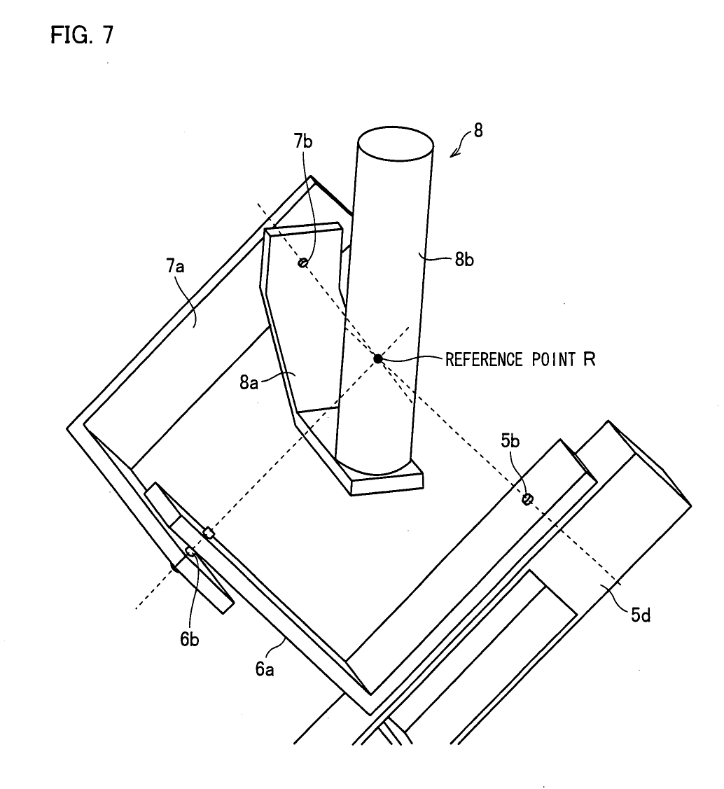

As FIG. 1 illustrates the handgrip controller 8 being held by a user, a detailed configuration of the handgrip controller 8 may be incomprehensible. A detailed configuration of the handgrip controller 8 is illustrated in FIG. 7

FIG. 7 illustrates a configuration of the handgrip controller 8 seen from the direction C in FIG. 1. As illustrated in FIG. 7, the handgrip controller 8 includes an L-shaped component 8a connected with the link 7a through joint 7b, and the grip 8b which is to be gripped by the user. Formed of the L-shaped component 8a and grip 8b, the handgrip controller 8 employs a gimbal mechanism.

Also, as illustrated in FIG. 7, a reference point R at which each rotation axis of joints 5b, 6b, and 7b is intersected is located inside the grip 8b. The joints 5a, 6b, and 7b are provided to rotate the handgrip controller 8 when the user moves just a wrist.

As illustrated in FIG. 2, the reference point R is located right above bending point R′ of link 5a in its perpendicular direction. In the other words, when the user places his forearm on the link 5a, the bending point R′ is that end point of the link 5a, which corresponds to the user's wrist. By setting the reference point R as described above, operational performance of the handgrip controller 8 is improved.

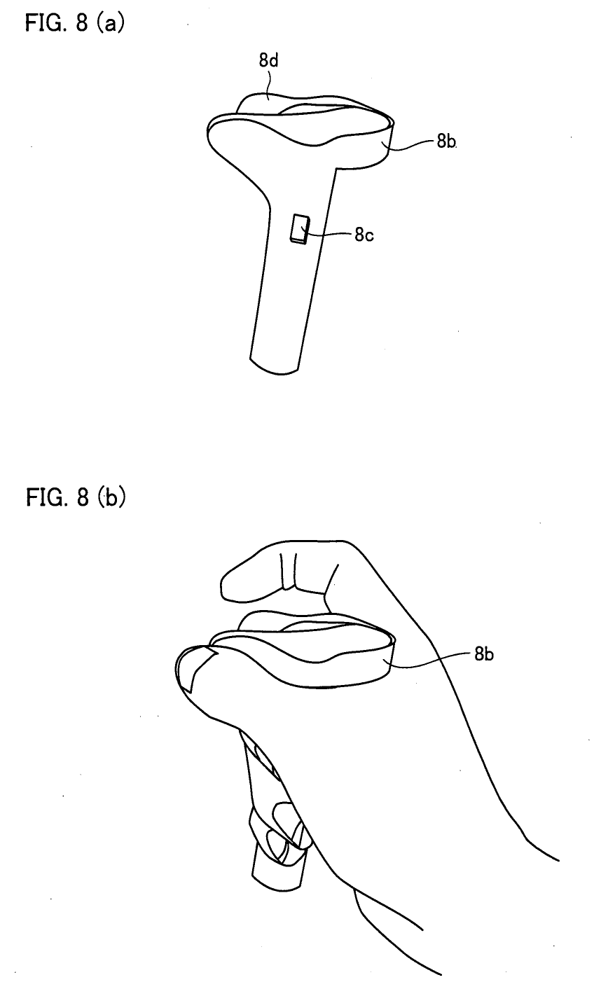

In FIG. 7, the grip 8b is illustrated as a bar. Needless to say, it is preferable that the grip 8b have a comfortable shape for a user, as illustrated in FIG. 8 (a). Moreover, the grip 8b may have a switch 8c so that a user turns on and off a function of converting motions of the master arm 1 to a robot arm. The user can hold the grip 8b in FIG. 8 (a) between a forefinger and a thumb, as illustrated in FIG. 8 (b).

The Grip 8b in FIG. (a) may have a lever which a user can operate by a forefinger. If a user can operate the lever, degree of freedom of a robot arm operated by the master arm 1 increases such as opening and closing a gripper of the robot, the gripper being provided at one end of the robot.

5. Footswitch

The master arm 1 in accordance with the embodiment would have such a trouble that when a user operates the elbow switch 10 back and forth (to the directions a and b in FIG. 1), the joint b that allows the back-and-forth movement of the user's arm would rotate, and consequently the elbow switch 10 cannot properly follow the motions of the user's arm. In order to avoid such trouble, it is preferable to provide a footswitch 1a, as illustrated in FIGS. 3 (a) and (b). Needless to say, footswitch is not the only way, but other switches are also available for this purpose. The following explanation describes the present invention, referring to the footswitch in FIGS. 3 (a) and (b) as one example.

It is arranged that the joint 2b (see FIG. 1) is locked when a user presses down on the footswitch 1a. A user presses down on the footswitch 1a as needed so that the elbow switch 10 precisely follows the motion of the user's elbow. It may be arranged such that joint which is locked when a user presses down on the footswitch 1a is another joint rather than the joint 2b.

Furthermore, if a user unintentionally moves the elbow switch 10, the robot arm may move unexpectedly. In order to avoid such trouble, it may be arranged such that the footswitch 1a has a function to turn on and off the motions control of the robot arm. By this function, the motions of the user's elbow detected by the elbow switch 10 will be conveyed to the robot arm only when the user presses down on the footswitch 1a. Herewith, a user can use elbow switch 10 as needed.

6. Functions of Master Arm

The configuration of the master arm 1 is described as above. And the master arm 1 includes the elbow switch 10 where a user places his elbow in accordance with the above description. The elbow switch 10 enables the master arm 1 to control two types of redundant degrees of freedom. The distinguishing function of the master arm 1 is described as follows.

First, the elbow switch 10 can detect the distances of the movement of a user's elbow in four directions (2 degrees of freedom) by the micro switches 14 and slide guides 15, as illustrated in FIGS. 6 (a) through (c). Each of the six joints of the master arm 1 (the joints 2b through 7b) has 1 degree of freedom, as illustrated in FIG. 2. So, the master arm 1 itself totally has 6 degrees of freedom.

As described above, the elbow switch 10 has 2 degrees of freedom and the master arm 1 itself has 6 degrees of freedom. That is, the master arm 1 can control motions with a total of 8 degrees of freedom (or a total of 9 degrees of freedom including 1 degree of freedom of opening and closing the gripper). The master arm 1 in accordance with this embodiment can remotely control the robot arm which has 7 or more degrees of freedom.

Especially, the master arm 1 of this embodiment enables a user to control the robot arm by operating the elbow switch 10 by his elbow. As the user can operate the robot arm without raising his elbow, the user will feel less tired even after operating the robot arm for many hours. Moreover, a user can operate the robot arm by moving his elbow. So the user can intuitively operate the robot arm.

The master arm 1 of this embodiment includes the master arm main body (the links 2a through 7a, joints 2b through 7b, and handgrip controller 8), and the elbow switch 10 provided at the position of the master arm main body where a user places his elbow. The master arm main body conveys motions of the user's elbow to the robot arm. The elbow switch 10 can perform a motion control with 2 degrees of freedom.

With the above configuration, the master arm 1 can have 2 more degrees of freedom provided from the elbow switch 10 in addition to the degrees of freedom of the master arm main body. That is, the master arm 1 enables a user to operate the robot arm with higher degrees of freedom.

As motions of the user's arm are conveyed to the robot arm by the master arm main body, the user can operate the robot arm as if it is a user's own arm. So the user can command more various motions to the robot arm.

Moreover, by providing the elbow switch 10 at a position where a user places his elbow, it becomes possible for the user to operate the elbow switch 10 while placing his elbow on the position. As a result, the user can intuitively operate elbow switch 10 with his own elbow, and long-hour control operation of the target to control becomes less fatiguing.

If the master arm includes a contact point with the user's elbow, by providing the elbow switch 10, the user can command more various motions to the robot arm.

It is preferable that the master arm 1 of this embodiment include an armrest 9 for supporting a user's elbow when the user moves his forearm in operating the master arm main body.

With this configuration, the armrest 9 regulates the movement of the user's elbow so that the elbow switch 10 properly follows the motions of the user's elbow.

It is preferable that the master arm 1 of this embodiment include an armrest 9 which works as a counterbalance when a user raises his forearm in operating the master arm main body.

With this configuration, the user can easily raise his forearm.

Also, it is preferable that the master arm 1 of this embodiment include a switch like the footswitch 1a which is capable of locking the joint 2b of the master arm main body. The joint 2b allows a user to move his elbow in a back-and-force direction.

With this configuration, the user operates the switch as needed, for example, pressing down on the footswitch 1a, so that the elbow switch 10 properly follows motions of the user's elbow.

Furthermore, It is preferable that the master arm 1 include a switch like the footswitch 1a for turning on and off motions control of the robot arm.

With this configuration, a user operates the switch as needed, for example, pressing down on the footswitch 1a, so that the elbow switch 10 can be turned on and off.

Moreover, it is preferable that a rotating axis of the joint 3 of the master arm main body passes through a contact point between the user's elbow and the armrest, or through a point slightly inside the user's forearm from the contact point. The joint 3 allows the user to move his forearm in an up-and-down direction.

With this configuration, the user can naturally move his forearm in an up and down direction, without moving his shoulder or upper body.

As described above, it is preferable that the remote control device of the present invention include an armrest for supporting a user's elbow when the user moves his forearm in operating the master arm main body.

With this configuration, the armrest regulates the user's elbow so that the elbow switch properly follows motions of the user's elbow.

It is preferable that the remote control device of the present invention includes an armrest which works as a counterbalance when a user raises his forearm in operating the master arm main body.

With this configuration, the user can easily raise his forearm.

It is preferable that the remote control device of the present invention include a switch which is capable of locking a joint of the master arm main body. The joint allows a user to move his elbow in a back-and-force direction.

With this configuration, the user operates the switch as needed so that the elbow switch properly follows the motions of the user's elbow.

Furthermore, it is preferable that the remote control device of the invention include a switch for turning on and off the motion control of the robot arm.

With this configuration, the user operates the switch as needed so that the elbow switch can be turned on and off. As for the switch, various types of switches are available like footswitch, hand switch.

Moreover, it is preferable that a rotating axis of a joint of the master arm main body passes through a contact point between the user's elbow and the armrest, or through a point slightly inside the user's forearm from the contact point. The joint allows the user to move his forearm in an up-and-down direction.

With this configuration, the user can naturally move his forearm in the up and down direction without moving his shoulder or upper body.

### INDUSTRIAL APPLICABILITY

A remote control device of the present invention is applicable to remote controls of various robots. Especially, the invention is most useful for a rescue robot for use in rescue operation.

This is because operators of the robot are not specialists in robots, but rescue workers. So, the rescue robot requires a remote control device by which they can intuitively operate the rescue robot. Of course, a remote control device that can be operated in a long time without much fatigue is preferable. In view of this, the remote control device of the present invention allows rescue workers to intuitively operate the robot and is also designed that a user feels can operate the robot for many hours without much fatigue.

Furthermore, the present invention is also useful for a construction robot (high performance construction machinery). In this case, too, operators are not specialists in robots, but construction workers. So, the rescue robot requires a remote control device by which they can intuitively operate the rescue robot. As described above, the remote control device of the present invention can satisfy this need.

1. A remote control device comprising;
a master arm main body for conveying a motion of a user's arm to a robot arm; and
an elbow switch at that position of the master arm main body on which a user places his elbow, the elbow switch allowing a motion control of at least 2 degrees of freedom,
the elbow switch including:
a baseboard;
a component capable of moving crosswise on the baseboard; and
detectors each of which is capable of detecting a distance of movement of the component.

2. The remote control device as set forth in claim 1 comprising an armrest for supporting a user's elbow when the user moves his forearm in operating the master arm main body.

3. The remote control device as set forth in claim 1 comprising an armrest which works as a counterbalance when the user raises his forearm in operating the master arm main body.

4. The remote control device as set forth in claim 1 comprising a switch which is capable of locking a joint of the master arm main body, the joint allowing a user to move his elbow in a back-and-force direction.

5. The remote control device as set forth in claim 1 comprising a switch which turns on and off the motion control of the robot arm which is performed by the elbow switch.

6. The remote control device as set forth in claim 2, wherein a rotating axis of a joint of the master arm main body passes through a contact point between the user's elbow and the armrest, or through a point slightly inside the user's forearm from the contact point, the joint allowing the user to move his forearm in an up-and-down direction.

7. The remote control device as set forth in claim 1 comprising another master arm, so that the master arms are provided respectively user's right arm and left arm.

8. The remote control device as set forth in claim 3, wherein a rotating axis of a joint of the master arm main body passes through a contact point between the user's elbow and the armrest, or through a point slightly inside the user's forearm from the contact point, the joint allowing the user to move his forearm in an up-and-down direction.
